(19) United States
(12) Patent Application Publication
(10) Pub. No.: US 2024/0148189 A1
(43) Pub. Date: May 9, 2024

(54) KITCHEN APPLIANCE

(71) Applicant: DE'LONGHI BRAUN HOUSEHOLD GMBH, Neu-Isenburg (DE)

(72) Inventors: Olga JOST, Neu-Isenburg (DE); Grigori KASPARYAN, Neu-Isenburg (DE); Markus UNGERER, Neu-Isenburg (DE)

(73) Assignee: DE'LONGHI BRAUN HOUSEHOLD GMBH, Neu-Isenburg (DE)

(21) Appl. No.: 18/281,396

(22) PCT Filed: Mar. 4, 2022
(86) PCT No.: PCT/EP2022/055631

§ 371 Date: Sep. 11, 2023

(30) Foreign Application Priority Data
Apr. 1, 2021 (GB) 2104786.5
Apr. 1, 2021 (LU) LU102724

(51) Int. Cl. A47J 43/07; A47J 43/046; A47J 43/08

(52) U.S. Cl. CPC A47J 43/0766; A47J 43/046; A47J 43/0727; A47J 43/0777; A47J 43/085

(57) ABSTRACT

A kitchen appliance is disclosed comprising a body to which one or more attachments may be fitted, the body comprising at least one sensor configured to distinguish between at least three conditions relating to a detectable element associated with an attachment, and a controller configured to identify a parameter relating to the attachment in dependence upon the sensed condition. Other embodiments are also disclosed.

### FIELD

The present invention relates to a kitchen appliance, in particular a kitchen appliance comprising a body to which one or more attachments may be fitted. The invention relates in particular to a sensor for identifying a parameter of an attachment. The invention extends to an attachment and an adaptor for the kitchen appliance.

### BACKGROUND

Kitchen appliances, such as blenders, food processors or stand mixers may be provided with a number of exchangeable attachments for different processing applications. Since each of the attachments serves a different purpose, it may need to be operated differently to achieve ideal results. For example, it might be necessary to run them at different speeds, for different operating times or to apply different speed or pulse profiles.

In many kitchen appliances, it is left to the user to apply the correct settings, which often leads to non-optimal operation and/or operation that is not safe (due to incorrect settings being applied). Alternatively, other kitchen appliances offer programs for each of the different attachments, which apply the ideal setting for each attachment, but where the programs need to be selected by the user. This still has the potential of user errors.

It is therefore desirable for a kitchen appliance to comprise an attachment recognition system, which (automatically) detects the attached attachment and selects the ideal program and/or limits the possible user inputs to those that are suitable for the attachment. This limits the risk of incorrect user inputs and improves the performance of the kitchen appliance (allowing it to operate with optimal settings). In addition, it also has safety benefits, for example because the automatic program selection can prevent unsafe conditions resulting from pressure build-up or overheating as a result of incorrect usage.

Current attachment recognition systems include attachment recognition via a RFID chip, and via mechanical actuating of one or more electrical switches.

In systems including attachment recognition via a RFID chip, the RFID chip is integrated into the attachment. This allows detection of a high number of different attachments and can be easily extended to new attachments without mechanical modifications to the device during its lifecycle. However, such systems are often excessively complex and/or expensive.

In turn, a mechanical system may comprise a rib/rod extending from the attachment into an aperture of the motor unit housing, where it actuates an electrical switch. To detect multiple attachments, multiple switches are needed, so that the attachment can be detected by activation of a dedicated switch or a certain combination of switches. The disadvantages of such a system include the motor unit not being water-tight due to openings for the actuator ribs, and limited flexibility in extending the system to new attachments. For example, it is not possible to add further attachments after product launch without mechanical and/or tooling changes on the main unit.

In order to provide the option for future extension of the number of attachments, the required number of switches and openings needs to be considered already in the product design, leaving even more openings in the housing (and exacerbating the water tightness issue). Further, this may make the system very expensive, especially if the attachments need to be attachable in more than one orientation on the device, for example to adapt to left-handed or right-handed users.

The present invention aims to at least partially ameliorate the above-described problems of the prior art.

### SUMMARY OF INVENTION

According to a first aspect of the invention, there is provided an appliance, preferably a kitchen appliance, comprising a body to which one or more attachments may be fitted, the body comprising at least one sensor configured to distinguish between at least three conditions relating to a detectable element associated with an attachment, and a controller configured to identify a parameter relating to the attachment in dependence upon the sensed condition.

By distinguishing between at least three conditions relating to the detectable element, the controller may be able to identify a greater number of parameters relating to an attachment (e.g. as compared to a mechanical system that may only detect two conditions). The conditions are preferably exclusive conditions. The conditions preferably comprise: the absence of a detectable element, and the presence of a detectable element having either a first or a second detectable condition or state which can be used to identify the attachment.

As used herein the terms “presence” and “absence” preferably connote the proximity or otherwise of the detectable element to the sensor, proximity preferably being within approximately 10 to 25 mm of the sensor (i.e. “presence” connoting the proximity being within this distance, and “absence” connoting the proximity being beyond this distance). Preferably, sensing the condition of the detectable element does not require contact between the detectable element and the sensor.

The detectable element preferably comprises a magnet (or magnetic element), and the first and second states comprise each polarity of a magnetic field of the magnet. Distinguishing between states based on magnetic field polarity may reduce the probability of incorrectly sensing the condition of the detectable element (e.g. as compared to distinguishing based on a range of values of the same polarity).

The first and second states may comprise a first and a second orientation of the detectable element respectively relative to the sensor.

Preferably, the magnet is provided adjacent an engagement region of the attachment, for engaging with the body of the appliance during use. Preferably the magnet is provided adjacent an edge of the engagement region with either a south or north pole closer to/facing the attachment outer surface. Preferably, the magnetic axis of the magnet is substantially perpendicular to the edge of the engagement region and/or to the sensor in use. Preferably, the magnet is provided adjacent a sidewall of the engagement region.

The sensor may be a hall sensor, preferably an omnipolar hall sensor.

The body preferably comprises a motor unit; preferably wherein the attachment comprises a food processing tool. The motor unit may be a base unit of the appliance, or may be part of a stand mixer. The food processing tool may be a container for a blender or food processor, a stand mixer tool, or a tool or wand of a hand held appliance such as a hand held blender.

The parameter relating to the attachment may comprise at least one of: the absence of an attachment, the identity of the attachment, a condition of the attachment, and a working parameter of the attachment. Preferably, a condition of the attachment includes one or more of: a safe condition such as proper fitting of the attachment to the body, or the fitting of an accessory such as a lid to the attachment; and an orientation of the attachment (with respect to the body) such as a left-handed and/or a right-handed orientation. Preferably, a working parameter relates to an operation parameter of the appliance, for example including one or more of: a drive speed or range of speeds of the attachment; an operating time; a motor speed or pulse profile; and a heating and/or cooling configuration. Preferably, the identity of the attachment includes a type of the attachment, such as a (blender) jug, or cup.

Preferably, the controller is arranged to transmit a control signal to a motor of the body in dependence upon the working parameter relating to the attachment.

In dependence upon the sensed condition, the sensor preferably transmits a ternary code to the controller. This may increase the number of parameters relating to the attachment that may be identified. Preferably, the ternary code comprises: a first value corresponding to the sensing of a first condition/state (e.g. a positive magnetic field), a second value corresponding to the sensing of a second condition/state (e.g. a negative magnetic field), and a third value corresponding to the sensing of a third condition (e.g. an absence of a magnetic field (of sufficient strength)).

For improved utility, the body may be configured for engagement with an attachment in at least two relative orientations. The orientations may be angular orientations, and/or preferably comprise: a left-handed orientation and a right-handed orientation, for example whereby a handle is positioned conveniently for a left-handed user or a right-handed user respectively.

In order to further increase the number of parameters relating to the attachment that may be identified, the body preferably comprises a plurality of sensors, each configured to distinguish between at least three conditions relating to a detectable element associated with an attachment.

Preferably, an engagement region of the body has a substantially triangular shape, or rounded triangular shape, preferably a substantially equilateral triangular shape. This can facilitate engagement of an attachment to the body, and/or allow engagement of an attachment in up to three orientations.

Preferably, the body comprises two sensors, each sensor being provided adjacent a distinct side of the triangular engagement region, preferably at, or near, the midpoint of each side.

The sensor may be provided adjacent an engagement region of the body for engaging with an attachment, preferably adjacent an edge of the engagement region, optionally wherein the sensor is provided adjacent a sidewall of the engagement region.

The engagement region of the body may have a rotationally symmetrical shape.

In order to improve the safety of the appliance, the controller is preferably configured to permit or prevent actuation of a motor of the body or base unit in dependence on the sensed condition of the detectable element.

The detectable element may be passive (i.e. not transmit a signal).

Optionally, a sensor is (instead or additionally) provided in the attachment, and a detectable element is (instead or additionally) provided in the body.

According to a further aspect of the invention, there is provided an attachment for an appliance, preferably a kitchen appliance, the attachment having an engagement region for fitting to an appliance body in at least two orientations, and comprising a magnet at or adjacent the engagement region configured to present one of a north pole or a south pole to a sensor of the appliance body.

By having an engagement region for fitting to an appliance body in at least two orientations, the utility of the attachment may be increased.

The engagement region preferably has a substantially triangular shape or rounded triangular shape, preferably a substantially equilateral triangular shape.

The attachment is preferably configured for engagement with an accessory (such as a cover or lid), and further comprises a biased member arranged to bias the magnet away from the engagement region and thus the sensor of the appliance body if the accessory is not engaged with the attachment (or correctly engaged or fitted).

The biased member may comprise a moveable element such as a rod, which may be provided in a handle of the attachment; preferably wherein the magnet is provided on or engaged with the element or rod and/or wherein the element or rod is provided for movement on a rail.

According to a further aspect of the invention, there is provided an adaptor for an appliance, preferably a kitchen appliance, wherein the adaptor is configured to engage with an attachment and a body of the kitchen appliance; and comprises at least one aperture configured to receive a magnet.

The adaptor may extend the range of attachments that may be fitted to the body of the kitchen appliance, and its apertures may allow identifying a parameter relating to the adaptor and/or to the attachment.

The adaptor may comprise two or more apertures each configured to receive a magnet. The adaptor may be arranged to adapt the body for use with the attachment.

Preferably, the presence and polarity (and/or orientation) and/or absence of the magnet in the aperture forms a ternary code that identifies a parameter relating to the adaptor and/or to the attachment.

In order to improve safety, the aperture preferably comprises a biased member arranged to bias a magnet in the aperture away from the body if the attachment is not engaged or correctly engaged with the adaptor.

According to a further aspect of the invention, there is provided a kitchen appliance as defined above or as described herein, further comprising an attachment comprising at least one detectable element configured for sensing by the at least one sensor of the base.

The attachment may be the attachment as defined above or as described herein.

The kitchen appliance may further comprise the adaptor as defined above or as described herein; wherein the adaptor is engaged or engagable with the attachment and the body; and wherein the detectable element comprises a magnet provided in the adaptor aperture.

The kitchen appliance may further comprise an accessory such as a cover, or a lid.

According to a further aspect of the invention, there is provided an interlock mechanism for a container and an accessory such as a lid for a kitchen appliance, the mechanism comprising: a rail; a member arranged on the rail and biased in a first direction; and a magnetic element or magnet engaged with the member; wherein, upon engagement of the lid to the container, the movable member is configured to move on the rail in a second, opposite direction, for actuating a hall sensor.

Providing a rail for the member may restrict movement of the member to the first and/or second directions, and may therefore restrict frictional contact between the member and its housing, thereby reducing wear of the member.

Optionally, the rod is arranged in a handle for the container.

The kitchen appliance as referred to above may be a table-top kitchen appliance, preferably a blender.

The invention also encompasses a kit of parts for constructing any of the apparatuses or apparatus elements herein described.

The invention extends to methods, system and apparatus substantially as herein described and/or as illustrated with reference to the accompanying figures.

The invention extends to any novel aspects or features described and/or illustrated herein.

Any apparatus feature as described herein may also be provided as a method feature, and vice versa. As used herein, means plus function features may be expressed alternatively in terms of their corresponding structure, such as a suitably programmed processor and associated memory, for example.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination. It should also be appreciated that particular combinations of the various features described and defined in any aspects of the invention can be implemented and/or supplied and/or used independently.

It should also be appreciated that particular combinations of the various features described and defined in any aspects of the invention can be implemented and/or supplied and/or used independently.

In this specification the word ‘or’ can be interpreted in the exclusive or inclusive sense unless stated otherwise.

As used herein, the term “removable attachment” (and similar terms such as “removably attachable” and “reversibly attachable”), as used in relation to an attachment between a first object and a second object, preferably connotes that the first object is attached to the second object and can be detached (and preferably re-attached, detached again, and so on, repetitively), and/or that the first object may be removed from the second object without damaging the first object or the second object; more preferably the term connotes that the first object may be re-attached to the second object without damaging the first object or the second object, and/or that the first object may be removed from (and optionally also re-attached to) the second object by hand and/or without the use of tools (e.g. screwdrivers, spanners, etc.). Mechanisms such as a snap-fit, a bayonet attachment, and a hand-rotatable locking nut may be used in this regard.

Furthermore, features implemented in hardware may generally be implemented in software, and vice versa. Any reference to software and hardware features herein should be construed accordingly.

Whilst the invention has been described in the field of domestic food processing and preparation machines, it can also be implemented in any field of use where efficient, effective and convenient preparation and/or processing of material is desired, either on an industrial scale and/or in small amounts. The field of use includes the preparation and/or processing of: chemicals; pharmaceuticals; paints; building materials; clothing materials; agricultural and/or veterinary feeds and/or treatments, including fertilisers, grain and other agricultural and/or veterinary products; oils; fuels; dyes; cosmetics; plastics; tars; finishes; waxes; varnishes; beverages; medical and/or biological research materials; solders; alloys; effluent; and/or other substances. Any reference to “food”, “foodstuff” or similar terms herein may be replaced by such working mediums.

The invention described here may be used in any kitchen appliance and/or as a stand-alone device. This includes any domestic food-processing and/or preparation machine, including both top-driven machines (e.g. stand-mixers) and bottom-driven machines (e.g. blenders or food processors). It may be implemented in heated and/or cooled machines. The invention may also be implemented in both hand-held (e.g., hand blenders) and table-top (e.g., blenders) appliances. It may be used in an appliance that is built-in to a work-top or work surface, or in a stand-alone device. The invention can also be provided as a stand-alone device, whether motor-driven or manually powered.

As used herein, the term “processing” preferably connotes any action relating to or contributing towards transforming products into foodstuff, or transforming foodstuff into a different form of foodstuff, including—as examples—applying mechanical work (e.g. for cutting, beating, blending, whisking, dicing, spiralizing, grinding, extruding, shaping, kneading etc.) and applying heat or cold. “Food” and “foodstuff” as used herein can include beverages and frozen material and material used in creating them (e.g., coffee beans).

As used herein the term “kitchen appliance” preferably connotes a kitchen appliance including at least a motor unit including a motor.

### BRIEF DESCRIPTION OF DRAWINGS

FIG. 1 shows a side-on drawing of a kitchen appliance according to an embodiment of the invention;

FIG. 2 shows a simplified top-view drawing of a motor unit;

FIG. 3a shows a simplified top-view drawing of the motor unit of FIG. 2 with an attachment connected in a first orientation;

FIG. 3b shows a simplified top-view drawing of the motor unit of FIG. 2 with the attachment of FIG. 3a connected in a second orientation;

FIG. 4 shows a simplified top-view drawing of an adaptor for a further attachment;

FIG. 5 shows a simplified top-view drawing of the motor unit of FIG. 2 with the further attachment connected;

FIG. 6 shows a cross-sectional side-on drawing of the motor unit and attachment of FIG. 3a or 3b;

FIG. 7 shows a cross-sectional side-on drawing of the motor unit and further attachment of FIG. 5;

FIG. 8a shows a simplified side-on drawing of a sensor and a magnetic element;

FIG. 8b shows a further simplified side-on drawing of the sensor and a magnetic element;

FIG. 9a shows a top-view drawing of a sensor;

FIG. 9b shows a top-view drawing of a further sensor and a magnetic element;

FIG. 10a shows a cross-sectional side-on drawing of the motor unit and attachment of FIG. 6 with a lid connected;

FIG. 10b shows a cross-sectional side-on drawing of the motor unit and attachment of FIGS. 6 and 10a without a lid connected;

FIG. 11 shows a circuit diagram of an embodiment of the sensor; and

FIG. 12 shows a circuit diagram of an embodiment of a signal flow circuit.

### SPECIFIC DESCRIPTION

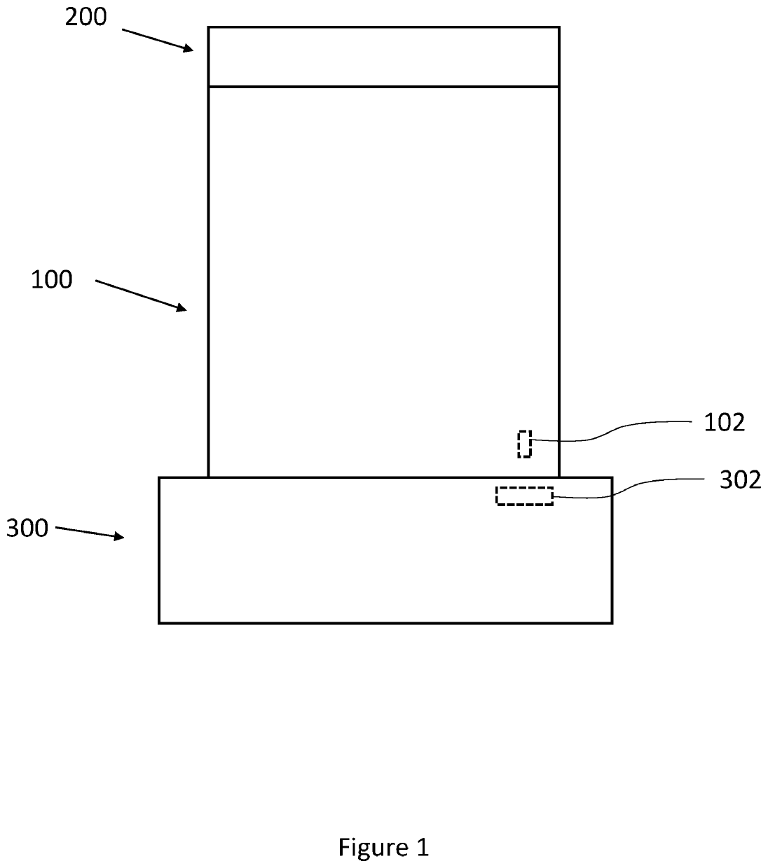

FIG. 1 illustrates a kitchen appliance 100 according to an embodiment of the invention. The kitchen appliance comprises a lid 200, an attachment 100, and a body (e.g. motor unit) 300. In this example, the motor unit 300 is configured to house a motor (not shown) and controller (control module) (not shown) for control of the motor and/or other features of the motor unit (e.g., heating/cooling units, lights etc.).

A plurality of different attachments 100 may be fitted (attached) to the motor unit 300, and each attachment 100 may require different motor and/or other settings of the motor unit to ensure safe operation and/or to improve performance. For example, each attachment 100 may have different requirements for maximum allowed motor speed and/or automatic preset settings that may be used and/or further features which may be used with the attachment (e.g. some attachments may be used with heating whereas others may not, and some may be used without a lid, whereas others may not).

Therefore, a method of detecting (recognising) attachments may enable differentiating between the attachments and setting the appropriate motor unit controls. Attachment recognition may make the kitchen appliance more convenient to use for the consumer by offering the best working speeds and individual features based on the used attachment. Further, it may improve the safety of the kitchen appliance, which may otherwise be compromised by user selection of unsafe settings for the particular type of attachment. For example, for a blender (in particular, a high-power blender), for safety purposes it is important to set the appropriate maximum motor speed setting and maximum blending time. As a further example, for a closed top attachment, appropriate and safe motor unit settings are important to control overpressure.

In this embodiment, the motor unit 300 is a base unit of an appliance, such as a blender or processor base unit, and the attachment 100 may be any one of: a jug, a cup (e.g. a smoothie-to-go cup), a chopper, a grinder, or a food processor attachment. However, the skilled person would appreciate that the present disclosure is equally applicable to further attachments and to other types of kitchen appliance that may use a plurality of attachments, such as a handheld kitchen appliance.

The motor unit 300 comprises one or more hall sensors 302 (e.g. bipolar or omnipolar hall sensors) configured to detect the presence and polarity of one or more magnetic elements 102 of the attachment 100, and thereby to recognise the attachment 100. Each attachment 100 may present a different magnetic element or combination of magnetic element(s) to the hall sensor(s), which may thereby uniquely identify the (type of) attachment.

A hall sensor that can detect the polarity of a magnetic field (also referred to as a “polarity” sensor) has the advantage over a regular (unipolar) hall sensor (or other magnetically actuated switching element) in that it can detect both the presence of a magnetic element (magnet), and its polarity (i.e. it can distinguish between the North and South pole of a magnetic element). Accordingly, a polarity hall sensor can distinguish between three different conditions (North pole (of) magnet/South pole (of) magnet/no magnet), as opposed to only two conditions in the case of a unipolar hall sensor (magnet present/no magnet present) or a mechanical switch (actuator present/no actuator present). This may allow the detection of more attachments with a smaller number of detection elements (in this embodiment, omnipolar hall sensors).

For example, even with a single magnetic element 102 and single sensor 302 it may be possible to differentiate between two attachments by presenting the South pole side of the magnetic element to the sensor for one attachment, and the North pole side for the other attachment (e.g.: Attachment 1 (North pole magnet)/Attachment 2 (South pole magnet)/no attachment (no magnet)). By using a higher number of sensors 302 and/or magnets 102 yet more different combinations of north pole, south pole and no magnet detections can be achieved thereby to detect (recognise) a plurality of attachments 100—see further details below. In contrast, for a system comprising regular hall sensor(s) (that cannot detect the polarity of a magnet), if the system needs to distinguish between more than one attachment, multiple magnet positions and sensors may be necessary, and one dedicated hall sensor needs to be provided for each possible magnet position. This quickly makes the system very expensive, especially if the attachments need to be attachable in more than one orientation on the device, for example to adapt to left-handed or right-handed users.

Further, the use of polarity hall sensors 302 may improve the extendibility of the kitchen appliance to new attachments devised after the motor unit has already been sold. When a kitchen appliance is first created or sold, it is often not clear whether additional attachments may be added later on, each of which may require a different set of control(s) (e.g. related to motor speed or different pre-set applications). The ‘south/north’ detection of a polarity hall sensor may allow more freedom (e.g. as compared to a regular hall sensor or a mechanical switch) to add additional attachments at a later stage without necessitating any changes (in particular, tooling changes) to the motor unit 300, due to the higher number of detection states (conditions) of each sensor 302 (North pole magnet/South pole magnet/no magnet). Thus, new attachments 100 may be detected by the kitchen appliance via magnet/sensor combinations unused during the initial design, which can then be utilized by future attachments 100.

In comparison to a mechanical switch recognition system, the present invention may also offer the advantage that no openings are needed in the motor unit 300 for detection elements. Therefore, additional detection elements do not pose any disadvantage with regards to cleaning or sealing of the motor unit 300.

In this embodiment, an attachment 100 is detected (recognised) in dependence on the detection of a presence and polarity of one or more magnets 102 of the attachment 100 by one or more sensors 302 of the motor unit 300. Each attachment (or attachment arrangement—e.g. left-handed or right-handed arrangement) may be assigned to a given combination of sensor 302 magnet detections (output signals). Table 1 below shows possible sensor output signal combinations for a number of exemplary arrangements comprising differing numbers of magnets 102 and sensors 302. The combinations where no magnets 102 are detected by the sensors 302 are not shown in Table 1, because these may be considered as pre-set “no attachment” conditions, where the kitchen appliance should not run.

TABLE 1

| | No. of | No. of | |
|---|---|---|---|
| | magnets | sensors | Possible sensor output signals (sensor 1/sensor |
| Layout | 102 | 302 | 2/. . .) |
| A | 1 | 1 | 2: 1. South (pole magnet); 2. North (pole magnet) |
| B | 1 | 2 | 4: 1. South/None (no magnet); 2. North/None; 3. |
| | | | None/South; 4. None/North |
| C | 2 | 2 | 8: 1. South/South; 2. South/North; 3. North/North; |
| | | | 4. North/South; 5. South/None; 6. North/None; |
| | | | 7. None/South; 8. None/North |
| D | 3 | 3 | 26: 1. South/South/South; 2. South/South/North; |
| | | | 3. South/North/North; 4. North/North/North; |
| | | | 5. South/North/South; 6. North/South/South; |
| | | | 7. North/North/South; 8. North/South/North; |
| | | | 9. South/South/None; 10. South/None/South; |
| | | | 11. None/South/South; 12. North/North/None; |
| | | | 13. North/None/North; 14. None/North/North; |
| | | | 15. North/South/None; 16. North/None/South; |
| | | | 17. None/South/North; 18. South/North/None; |
| | | | 19. South/None/North; 20. None/South/North; |
| | | | 21. South/None/None; 22. None/South/None; |
| | | | 23. None/None/South; 24. North/None/None; |
| | | | 25. None/North/None; 26. None/None/North |

As shown in Table 1, Layouts A, B, C, and D may respectively be able to detect up to: 2, 4, 8, and 26 attachments 100. This is significantly more than may be possible using regular/unipolar sensors or a mechanical switch system. For example, Layout C used with unipolar sensors or mechanical switches may only be able detect three possible attachments: (1. ON/ON; 2. ON/OFF; 3. OFF/ON) as compared to the eight possible combinations for a bi-polar hall sensor system as described herein and showed in Table 1.

In some embodiments, it may be possible to attach one or more attachments 100 in a plurality of different orientations (or arrangements or positions)—e.g. two orientations to allow users to adjust to left-handed or right-handed use of the attachment. Accordingly, since it may be needed to detect a single attachment 100 in different orientations, fewer attachments 100 may be detected with the same number of sensors 302 and magnets 102, whilst avoiding ambiguous combinations. For example, in a kitchen appliance with two possible attachment orientations, two sensors 302 in the motor unit 300 and one south pole magnet 102 in the attachment 100, the connection of the attachment 100 may generate a ‘South/None’ or ‘None/South’ sensors 302 output signal, both corresponding to the same attachment 100. Therefore, the maximum number of detectable attachments 100 may be reduced as compared to a kitchen appliance with a single (fixed) attachment orientation.

More generally, the number of detectable attachments may vary in dependence on a range of factors such as: the angular spacing between possible attachment 100 orientations on the motor unit 300, the distribution of the magnets 102 on the attachments 100, and/or the number of used sensors 302 and/or magnets 102. As a result, many different arrangements of motor units 300, attachments 100 and sensors 302 and magnets 102 thereon are possible.

In an alternative embodiment, the motor unit 300 may comprise a user-interface allowing user control of the motor and other features of the base-unit (e.g., heating/cooling units, lights etc.) as well as providing feedback to the user. For example, the detection of an attachment by the hall sensors 302 may restrict the range of available settings to those corresponding to the detected attachment, and the user may select the desired settings among the restricted range.

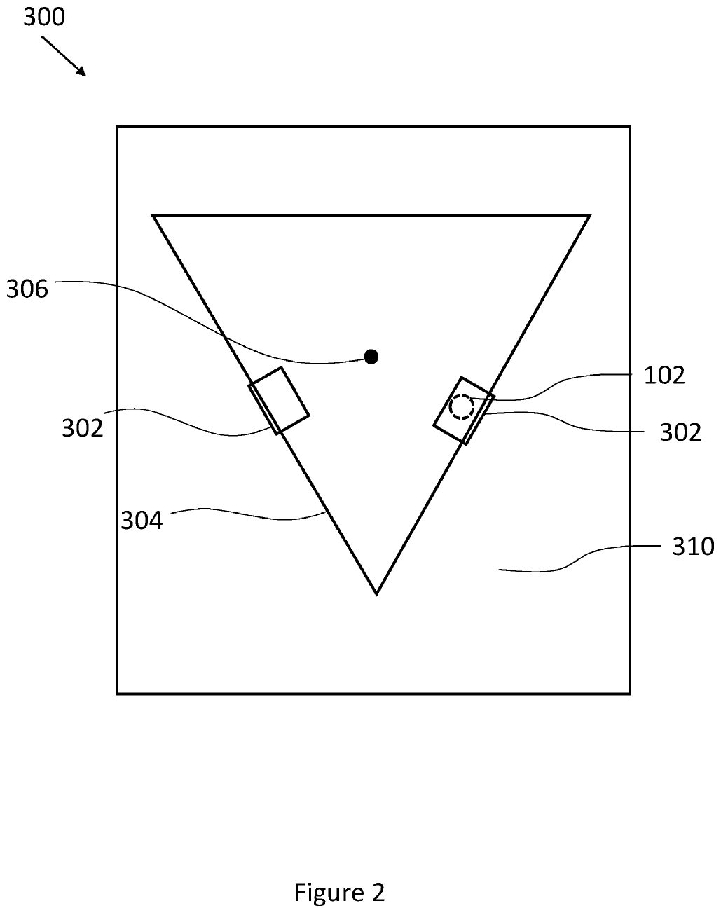

FIGS. 2 to 10b illustrate an example kitchen appliance in accordance with the present disclosure. The kitchen appliance comprises a motor unit 300 configured to receive either of attachments 100a or 100b. In the example illustrated in FIGS. 2 to 10b, the motor unit 300 is a blender base, attachment 100a is a blender jug, and attachment 100b is a ‘smoothie-to-go’ cup (referred to as “cup” below).

FIG. 2 illustrates a top-view of the motor unit 300. The motor unit 300 comprises a receiving portion (engagement region) 304 configured to receive (engage with) an attachment (not shown in this figure), two hall sensors 302 and a drive shaft 306 for transmitting drive from a motor of the motor unit 300. The receiving portion 304 may be shaped to match the shape of an attachment 100 to enable engagement to the attachment 100. In this embodiment, the receiving portion 304 is raised from the motor unit housing 310. Alternatively, the receiving portion 304 may be recessed into the motor unit housing 310.

In this embodiment, the receiving portion 304 and attachments 100a and 100b have a triangle-shaped cross-section. Preferably, said triangle shape is an equilateral triangle shape. Optionally, the triangle(s) may have curved sides and/or corners to allow easier fitting of an attachment 100 and the motor unit 300. The equilateral triangle shape of the receiving portion 304 of the motor unit 300 may allow locating the attachments 100 in up to three different positions.

The sensors 302 may be located at (or near) the midpoint of the sides of the triangle, to ensure sufficient spacing between the sensors 302, or to maximise the spacing. The three attachment 100 positions and the two sensors 302 may be spaced from one another by about 120°. The sensors 302 are preferably located at a sufficient distance from one another such that a magnetic element 102 in the vicinity of one sensor 302 may not inadvertently be detected by the other sensor 302. The sensors 302 are also preferably located at (or near) the boundary of or within the receiving portion 304 so that magnetic element(s) 102 may be positioned within the attachment 100 without the need to modify the external shape of the attachment 100 (e.g. extend its perimeter). More preferably, the sensors 102 are located at (or near) the boundary of the receiving portion 304, thereby further from the motor or other processing tools that may damage the sensors (e.g. via heating or vibration).

In an alternative embodiment, the receiving portion 304 and attachments 100 may have any other cross-section shape. Shapes with at least two lines of symmetry (e.g. square, rectangle, or hexagon) may be preferred because these may allow securing the attachment 100 to the motor unit 300 in at least two different orientations thereby allowing configuration for right- and left-handed use of the attachment 100.

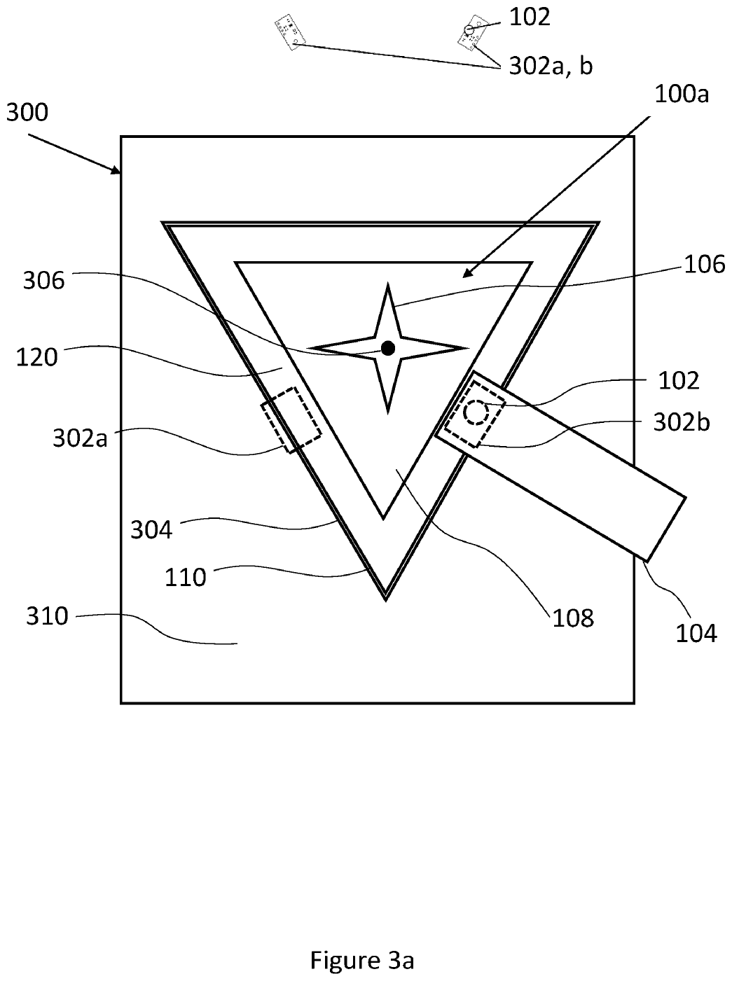

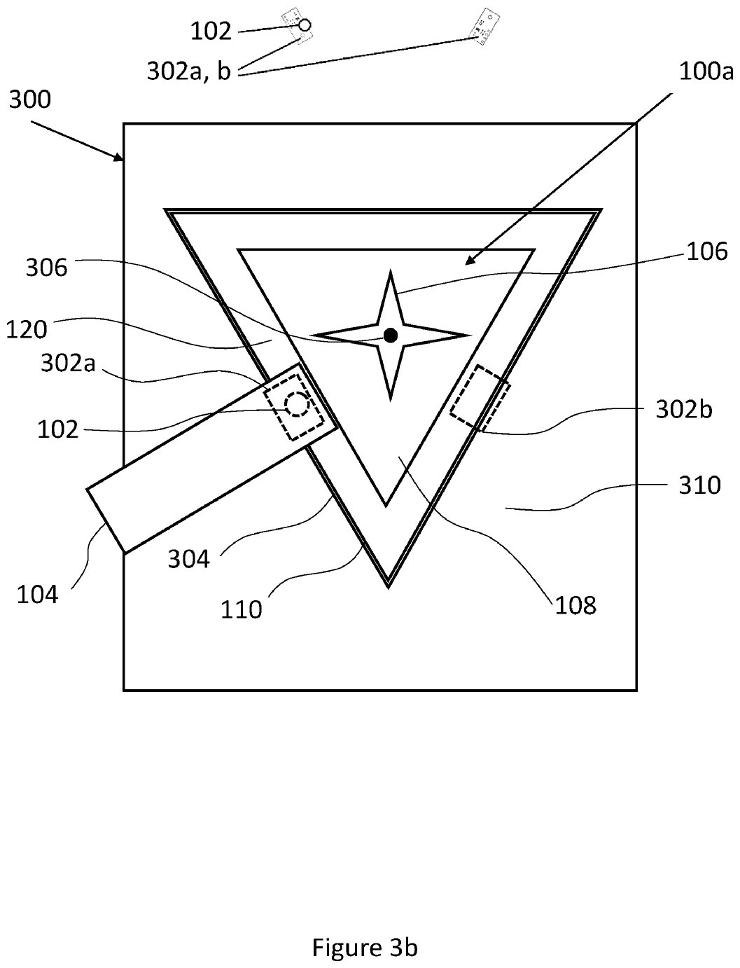

FIGS. 3a and 3b illustrate a top-view of a kitchen appliance comprising the motor unit 300 of FIG. 2 and an attachment 100a. FIG. 3a illustrates the attachment 100a in a right-handed orientation, and FIG. 3b in a left-handed orientation. FIGS. 3a and 3b further show a cross-sectional view of the sensors 302a,b and magnetic element 102 only (shown above the main illustration of the kitchen appliance).

The attachment 100a comprises a housing 120, having an engagement region (e.g. outer perimeter wall 110) configured closely to match the shape of the receiving portion 304 of the motor unit 300, a magnetic element 102, and a food processing tool 106 configured to receive drive from the shaft 306. The inner surface of the attachment housing 120 defines a food processing section (processing container) 108 of the attachment 100a where food processing takes place during operation of the kitchen appliance.

The attachment also comprises a handle 104. The magnetic element 102 may be located within, preferably at, or near, the bottom end (along the shaft 306 axis) of the handle 104. In this way the magnetic element may serve a dual purpose of identifying the attachment 100a (and/or its orientation) and confirming that a lid 200 has been attached to the attachment 100a (see further details below).

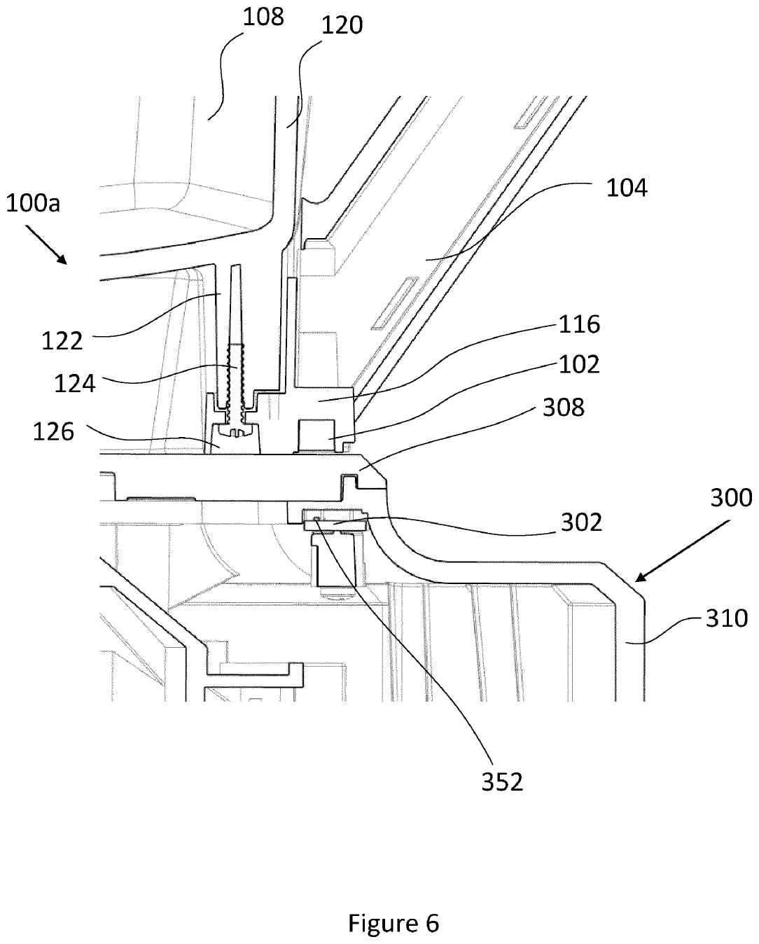

The magnetic element 102 is positioned such that when the attachment 100a is engaged to the motor unit 300, the magnetic element 102 is detected by the sensor 302. In particular, as shown e.g. in FIGS. 6, 7, 8a, 8b, the magnetic element 102 may be arranged above (along the shaft 306 axis) the sensor 302.

As shown in FIGS. 3a and 3b, the attachment 100a can be attached in two orientations (120° apart), to allow left- and right-handed use of the attachment 100a. In this exemplary embodiment, the magnetic element 102 is positioned so that it presents its North pole to the sensor 302, and is located at the bottom end of the handle 104. As a result, the magnet 102 actuates either the left hall sensor 302a or right hall sensor 302b, depending on the orientation of the attachment 100a and thus the position of the handle 104. Accordingly, the orientation of the attachment 100a may be detected.

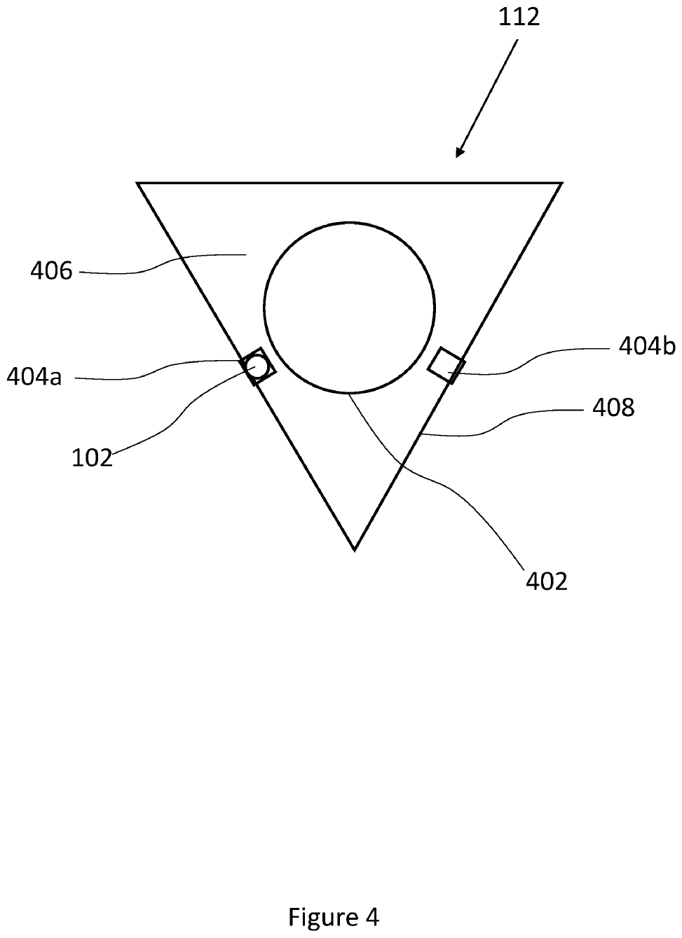

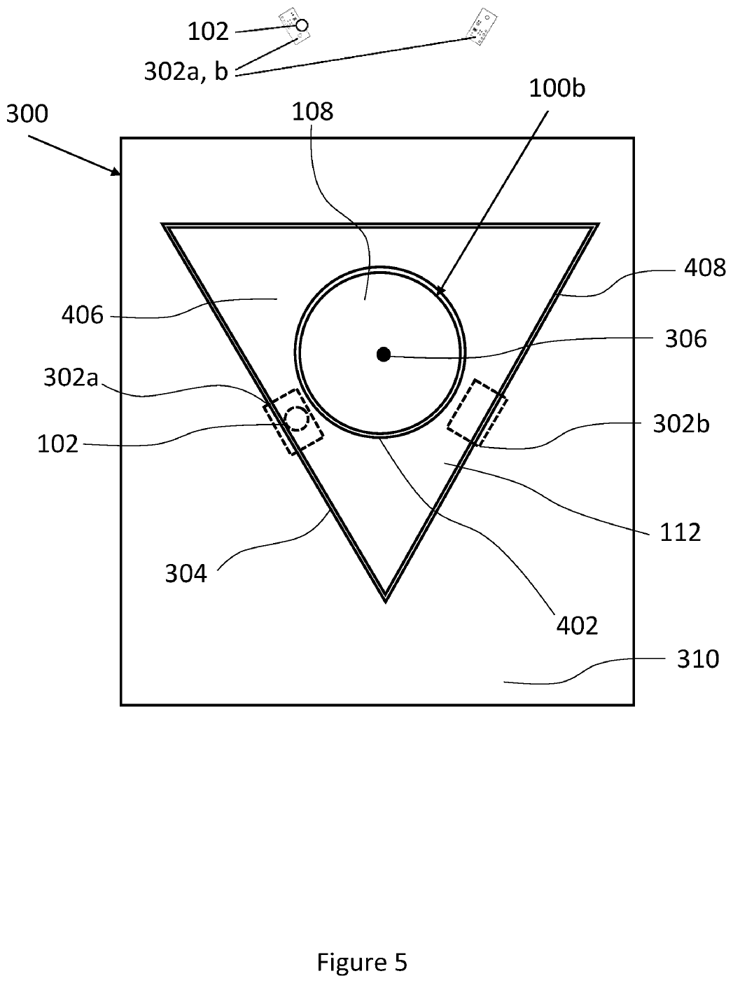

FIG. 4 illustrates a top-view cross-section of an adaptor 112 for an attachment 100b, and FIG. 5 illustrates a top-view cross-section of a kitchen appliance comprising the motor unit 300 of FIG. 2, adaptor 112 of FIG. 4 and attachment 100b. FIG. 5 further shows a cross-sectional view of the sensors 302a,b and magnetic element 102 only (shown above the main illustration of the kitchen appliance).

The use of the adaptor 112 may enable engagement to the motor unit 300 of an attachment 100b shaped differently to the receiving portion 304 of the motor unit 300. In this exemplary embodiment, the attachment 100b is a cup that is cylindrically shaped and thus requires an adaptor 112 to enable engagement to the motor unit 300. The attachment 100b may thus be engaged to the adaptor 112 which in turn is engaged to the receiving portion 304 of the motor unit 300.

The adaptor 112 comprises an adaptor body 406 defined by an (outer) perimeter wall 408 configured closely to match the shape of the receiving portion 304, for example to fit within it, and an (inner) perimeter wall 402 configured closely to match the shape of the attachment 100b, for example to receive it, and to engage with the attachment 100b. The adaptor body 406 may thus act as an engagement region for engaging the adaptor 400 to the motor unit 300. The adaptor body 306 may further comprise one or more apertures to reduce weight and/or improve air flow around (and thus cooling of) the attachment 100b.

The adaptor 112 also comprises one or more (in this example, two) slots 404 (e.g. apertures) each configured to receive a magnet 102. In the example embodiment of FIGS. 4 and 5, the left-sided slot 404a is fitted with a South pole magnet (i.e. a magnet that presents its South pole to the sensor 302) 102, and the adaptor 112 may be configured so that it can only be engaged with the receiving portion 304 of the motor unit 300 in one orientation. Thus, the South pole magnet 102 actuates the left-sided sensor 302a of the motor unit 300 when the adaptor is fitted.

The attachment 100b may be engaged to the adaptor 112 in a plurality of orientations. Preferably, the attachment 100b may be engaged to the adaptor 112 in three orientations as defined by the-triangle shaped adaptor 112 and receiving portion 304. The orientations may be defined by engagement means (for engaging the attachment 100b to the adaptor 112) arranged at the corners and/or sides of the triangle shaped adaptor body 406. The engagement means (not shown) may comprise a mechanism such as a snap-fit, or a bayonet attachment.

FIG. 6 illustrates a cross-sectional side-view of the kitchen appliance of FIG. 3a or 3b. As shown in FIG. 6, the magnetic element 102 is positioned at the bottom end of the handle 104. In this example, the attachment housing 120 comprises a cut-away portion 126 configured to receive a protruding portion 116 adjacent the handle 104, which may thus be engaged with the attachment housing 120 via securing means 124 (e.g. a screw) that engages the protruding portion 116 to the adjacent attachment housing portion 122.

The attachment 100a is removably attached to the motor unit 300 by suitable latches or other attachment means. For example, the receiving portion 304 of the motor unit 300 may comprise one or more protrusions (not shown) and the (bottom surface of the) attachment 100a may comprise corresponding slots (not shown) configured for receiving the protrusions. The attachment 100a may thus be placed (dropped) on top of the motor unit 300 and held in place by gravity. The attachment 100a may further, or alternatively, be connected to the motor unit 300 via latches, a bayonet mechanism and/or snap fit mechanism.

In order to hold the magnet 102 in place, the magnet may be pressed against a surface of the attachment 100a and attached via an adhesive (e.g. glued).

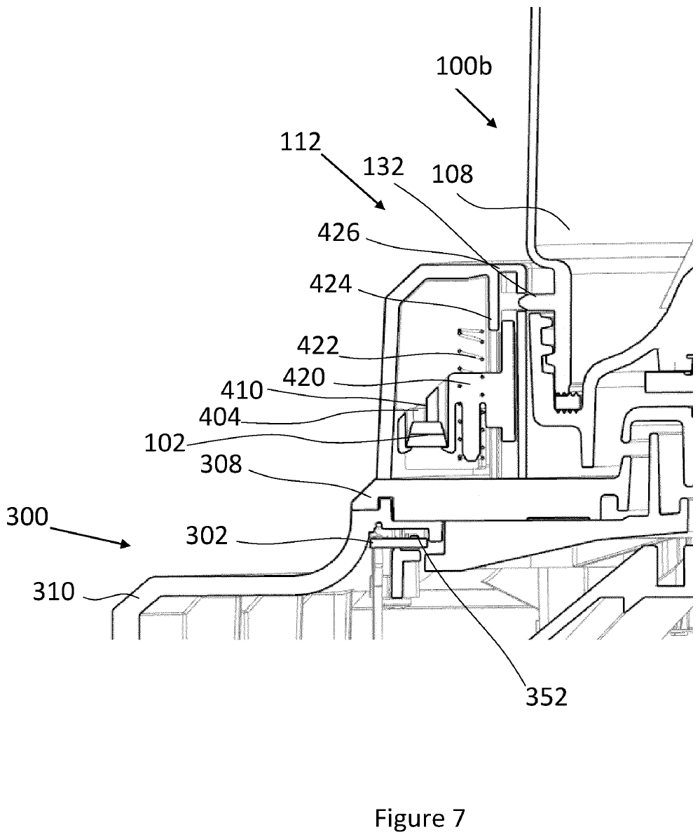

FIG. 7 illustrates a cross-sectional side-view of the kitchen appliance of FIG. 5. The adaptor 112 is removably attachable to the motor unit 300. For example, similarly to the attachment 100a shown in FIG. 6, the receiving portion 304 of the motor unit 300 may comprise one or more protrusions (not shown) and the (bottom surface of the) adaptor 112 may comprise corresponding slots (not shown) configured for receiving the protrusions. The adaptor 112 may thus be placed (dropped) on top of the motor unit 300 and held in place by gravity. The adaptor 112 may further, or alternatively, be connected to the motor unit 300 via latches, a bayonet mechanism and/or snap fit mechanism.

A slot 404 is provided in the periphery of the adaptor 112, and is configured for receiving a slot body 420 having a magnetic element 102. The slot 404 comprises a receiving portion (e.g. rails 410) that is in contact with the magnet 102. The slot 404 may employ a mechanism in order to hold the magnetic element 102 in place in the slot 404. For example, the magnet may be secured in the slot 404 via a snap fit mechanism (not shown). Alternatively, the rails 410 may comprise a ferromagnetic metal such as iron and thus hold the magnetic element 102 in place via a magnetic force of attraction, or the magnet 102 may be held in place by being positioned between a base and (optionally spring-loaded) cover.

The attachment 100b is removably attachable to the adaptor 112—for example, via a bayonet mechanism. The bayonet mechanism may comprise one or more ribs 132 provided in the attachment 100b that engage with a corresponding receptor in the adaptor 112.

The slot body 420 may be biased away from the sensor 302 when the attachment 100b is not engaged with the adaptor 112, so as to act as a safety interlock, indicating the absence of an attachment. For example, as shown in FIG. 7 the slot body 420 may be biased on a spring 422. When the attachment 100b is engaged with the adaptor 112, the ribs 132 may actuate a mechanical pusher (not shown) that moves the slot body 420 ‘down’ against the spring and thus moves the magnet 102 sufficiently close to the sensor 302 to be detected by it. In turn, when the attachment 100b is not engaged with the adaptor 112, the slot body is biased ‘up’ by the spring 422 (e.g. up to the point where the slot body comes in contact with the protrusion 424 and/or adaptor housing upper surface 426) and away from the sensor 302 and is no longer detected by it.

As shown in FIGS. 6 and 7, the sensor 302 is preferably positioned near the top surface of the motor unit 300 to enable detection of a magnetic element 102 of the attachment 100a or adaptor 112. The Hall element 352 of the sensor 302 is positioned directly in line with the magnetic element 102 and arranged perpendicularly to the direction of the magnetic field of the magnetic element 102.

As shown in FIGS. 6 and 7, the motor unit 300 may further comprise a centering pad 308 (preferably a silicon centering pad) fitted on top of the motor unit housing 310. The pad 308 forms the top cover of the motor unit 300. The pad 308 and the motor unit housing 310 may form a seal, so as to prevent water ingress into the motor unit 300.

The blade group (not shown) of attachment 100b may be attached by a thread (not shown), which may also be used to attach a cover (e.g. a lid) to attachment 100b, for example after blending.

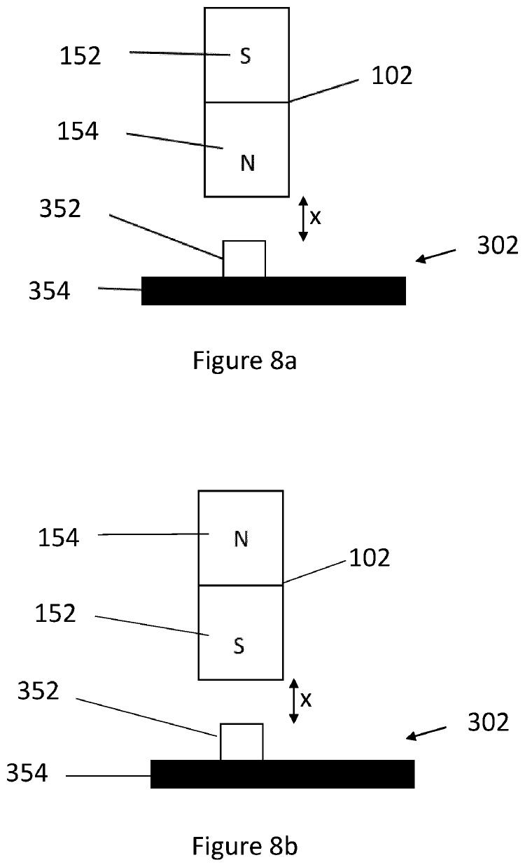

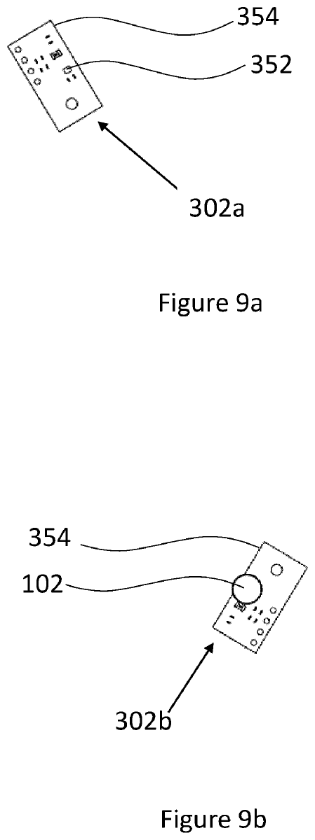

FIGS. 8a and 8b each illustrate a simplified side-view of a magnetic element 102 and hall sensor 302 in a kitchen appliance of FIGS. 3a/b and 5 respectively. FIG. 9a illustrates a top-view of sensor 302a of FIG. 3b. FIG. 9b illustrates a top-view of sensor 302b and magnetic element 102 of FIG. 3b.

The magnetic element 102 may be any object that produces a magnetic field, and, as shown in FIGS. 8a and 8b, it comprises a South pole 152 and North pole 154. The magnetic element is preferably a permanent magnet. For example, the magnetic element 102 may be a neodymium (NdFeB) magnet, such as a grade N38 magnet (with a magnetic flux density in the range 3.9-4.2 mT) or a grade N52 magnet (with a magnetic flux density in the range 4.2-4.5 mT). In this example, a grade N38 (3.9-4.2 mT) magnet is used for attachment 100a (a jug), and a grade N52 (4.2-4.5 mT) magnet is used for attachment 100b (a cup). The grade (strength) of the used magnet may depend on the distance between the magnet 102 and sensor 302 at which the magnet is to be detected, with a higher grade magnet (and thus a higher maximum energy product of the magnet) being used when this distance is greater. The size of the magnet 102 is preferably between 5 to 10 mm in diameter, and 2 to 6 mm in thickness; more preferably approximately 6 mm in diameter and approximately 5 mm in thickness.

Alternatively, the magnetic element 102 may be an electromagnet powered by an electric current.

The hall sensor 302 comprises a printed circuit board assembly (PCBA) 354, and Hall element 352. The PCBA 354 preferably comprises an integrated circuit (IC), described in further detail below. The Hall element 352 of sensor 302b is not shown FIG. 9b as it is underneath the magnetic element 102.

The Hall element 352 is responsible for detecting the magnet 102. When the magnet 102 is placed sufficiently close to the Hall element 352 of the sensor 302 and the magnetic field passing through the element 352 is sufficiently strong, the sensor 302 detects the presence and polarity of the magnet 102 and transmits a corresponding signal to a controller of the motor unit 300. Accordingly, the sensor 302 can differentiate between attachment 100a (for which the magnet 102 is arranged such that its North pole 154 is facing the element 352) and attachment 100b (where the magnet 102 is arranged such that its South pole 154 is facing the element 352).

In more detail, as the attachment 100a (or adaptor 112) is attached to the motor unit 300, the magnetic element 102 approaches the active area (or Hall element) 352 of the sensor 302 “head-on”. As a result, the magnetic element's magnetic field is perpendicular to the Hall element 352 and deflects charge carriers in the element 352 thereby generating a potential difference (Hall voltage) across the element 352. This voltage is proportional to the magnetic flux density of the magnetic field passing through the element 352.

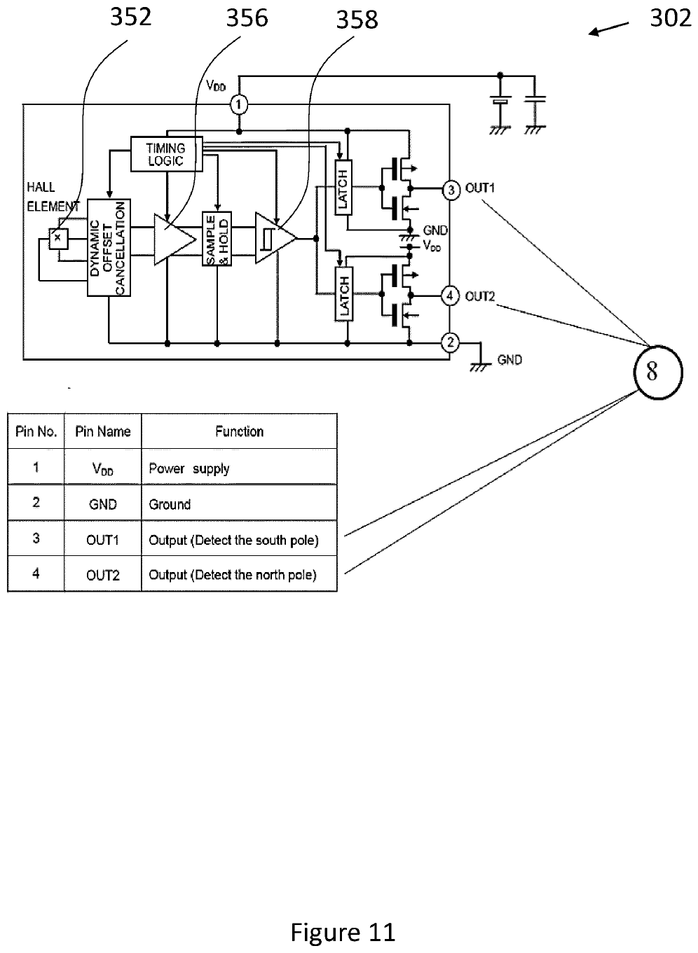

As described in further detail with reference to FIG. 11, the sensor 302 is preferably integrated in an integrated circuit (IC) comprising a Schmitt-trigger with built in hysteresis connected to an op-amp. In this way, the output signal from the device only switches when the magnetic flux passing through the element 352 exceeds a pre-set value, and the built-in hysteresis eliminates oscillation of the output signal as the magnetic element is moved towards and away from the element 352. The pre-set magnetic flux value is preferably between 1.5 and 3 mT, more preferably between 2 and 2.4 mT. A different pre-set magnetic flux value may be used for switching the sensor “ON” (changing to a state corresponding to the detection of a presence of a magnet 102) than for switching the sensor “OFF” (changing to a state corresponding to the detection of an absence of a magnet 102) to reduce oscillation of the output signal. For example, the sensor may be switched from “OFF” to “ON” when the magnetic flux passing through the element 352 is greater than 2.4 mT, and switched from “ON” to “OFF” when the magnetic flux passing through the element 352 is lesser than 2.0 mT. The pre-set magnetic flux value required for switching of the output signal may correspond to the magnetic flux passing through the element 352 when the distance between the Hall element 352 and the magnetic element 102 is x. For example, switching of the output signal may only occur if the magnetic element 102 is at a distance equal or lesser than x to the Hall element 352. The range of distances between the sensor 302 (Hall element 352) and the magnetic element 102 at which the presence of the magnetic element 102 is detected may depend on the magnetic element 102 used.

For example, for a grade N38 (3.9-4.2 mT) magnet, as used in this example for attachment 100a, the presence of the magnetic element 102 may be detected when this distance is in the range 10 to 25 mm, preferably 11 to 20 mm. Or, for a grade N52 (4.2-4.5 mT) magnet, as used in this example for attachment 100b, the presence of the magnetic element 102 may be detected when this distance is in the range 15 to 25 mm, preferably 16 to 23 mm.

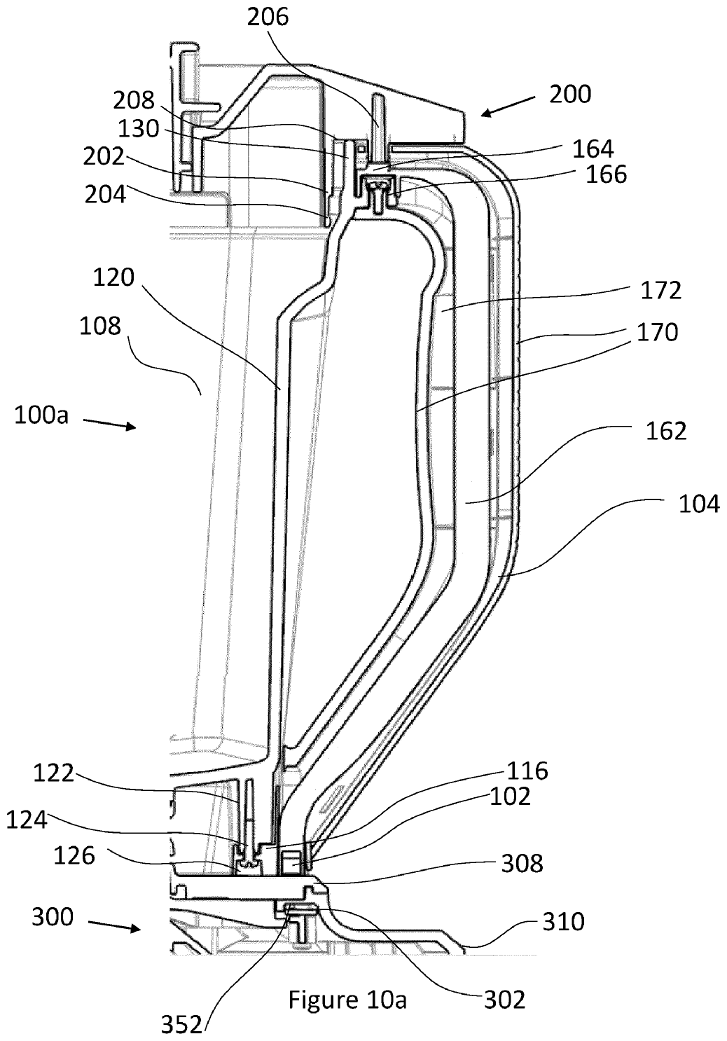

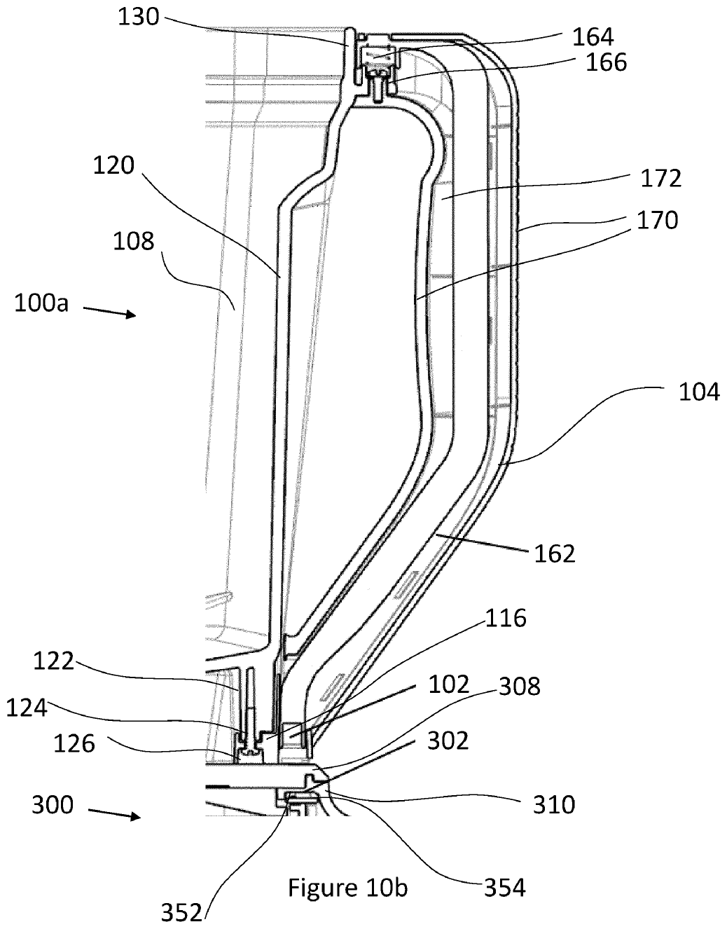

FIGS. 10a and 10b illustrate a cross-sectional side-view of a kitchen appliance comprising the motor unit 300 and attachment 100a of FIGS. 3a/b and 6. FIG. 10a illustrates the kitchen appliance with a cover, and FIG. 10b illustrates the kitchen appliance without a cover.

As shown in FIG. 10a, the attachment 100a may be closed by a cover such as the lid 200, which is attached to the attachment 100a by means of (for example) bayonet engagement features 204 on a flange 202 of the lid 200 engaging with corresponding features (not shown) provided on an upper part of the side wall of the attachment 100.

Alternatively, the lid 200 and the attachment 100a may have other corresponding locking formations to secure the connection, such as a snap lock.

In addition to the detection (identification) of an attachment and the presence of the attachment as described above, the hall sensor system may also be used as an interlock system to increase safety of the kitchen appliance. In particular, the interlock system may be used to detect the presence of a lid 200 attached to the attachment 100a (and/or a cover for its processing container 108) or the correct assembly of the attachment 100a. The interlock system preferably determines whether drive is transmitted. For example, the interlock system may prevent drive transmission when the lid 200 is not engaged with the attachment 100a.

An example interlock system for detecting the presence of the lid 200 using the magnetic element 102 and sensor 302 is shown in FIGS. 10a and 10b. The magnetic element 102 is mounted to the bottom end of a rod 162 positioned within the handle 104 (i.e. in the space 172 enclosed by the handle side wall 170). The rod 162 moves upon detachment or attachment of the lid 200 to attachment 100a and acts as a biased member which is actuated/depressed by the attachment of the lid 200 to the attachment 100a. If the lid 200 is not attached as shown in FIG. 10b, the rod 162 (and accordingly the magnet 102 mounted to the rod 162) moves away from the hall sensor 302, so that a “no lid/attachment” output signal is transmitted to a control module of the motor unit 300 thereby preventing the motor unit from running (e.g. its motor from transmitting drive). Conversely, if the lid 200 is attached correctly as shown in FIG. 10a, the rod 162 and magnet 102 moves towards the sensor 302 which may detect it and transmit a corresponding output signal.

In more detail, in this example, the upper part 164 of the rod 162 is positioned on one or more rails 166 extending from the attachment housing 120. The rails 166 are biased by a spring 168 (e.g. a coil-spring) positioned below the upper part 164 of the rod 162, such that in the absence of an opposite force on the upper part 164, the spring pushes the movable rod 162 upwards (away from the sensor 302) as shown in FIG. 10b. The uppermost possible position of rod 162 is defined by the top surface of the handle side wall 170. The lid 200 comprises a push-rod 206 configured to exert a force (in a direction opposite to the direction in which the spring 168 extends) on the upper part 164 of the handle rod 162 when the lid 200 is engaged to the attachment 100a. Accordingly, the engagement of the lid 200 causes the handle 162 and magnet 102 to move towards the sensor 302. The maximum downwards motion of the rod 162 (and the force exerted by the pushing rod 206) is defined by the contact of the bottom surface 208 of the lid and the upper end of the attachment housing 130 (which define the maximum downwards distance of the movable rod 162 and thereby the force exerted on the spring via Hooke's Law) which may allow avoiding damage to the various components.

Table 2 illustrates example output signals from the sensors 302a and 302b of the motor unit 300 configured to receive one of attachments 100a or 100b as described with reference to FIGS. 2 to 10b. By using two sensors 302a and 302b, up to 8 different magnet combinations (and thereby attachments (or attachment arrangements)) may be detected (see Layout C in Table 1). Three magnet combinations are required to detect attachment 100a in two orientations and attachment 100b. This leaves five magnet combinations open for future use as shown in Table 2. These ‘open’ combinations can be used for future attachments, without the need for mechanical changes to the motor unit 300. This is an advantage over a system with mechanical switches or unipolar hall sensors (that can detect only the presence of a magnet but not its polarity) using two switches/sensors which would already have used up all detectable conditions with the two attachments 100a and 100b and would not allow for any future expansion.

Thus, the present disclosure may provide a safer and more cost-effective attachment recognition system, which also offers the flexibility for extension (i.e. compatibility with further attachments 100), in case new attachments 100 are required after launch.

TABLE 2

| Left Sensor | Right Sensor | |
|---|---|---|
| 302a | 302b | Detected Condition |
| None (no magnet | None | Attachment (and/or lid) |
| detected) | | not engaged |
| North (pole of | None | Attachment 100a (jug) engaged in |
| magnet detected) | | left-handed orientation |
| None | North | Attachment 100a (jug) engaged in |
| | | right-handed orientation |
| South (pole of | None | Attachment 100b (cup) engaged |
| magnet detected) | | |
| None | South | Open for future use |
| South | North | Open for future use |
| North | South | Open for future use |
| North | North | Open for future use |
| South | South | Open for future use |

The number of magnet combinations that may be used to identify attachments 100 for the motor unit 300 may be reduced if a magnet 102 is used both to identity an attachment 100 and as part of an interlock system as described with reference to FIGS. 10a and 10b. If a magnet 102 is used as a lid 200 interlock, then certain magnet combinations may not be available for use, because they may create an ambiguous output signal. For example, an attachment 100 comprising a South/South combination (i.e. an attachment 100 comprising two magnets 102 both presenting their South poles 152 to two sensors 302) may be detected as a South/None combination if one magnet 102 is used for interlocking and the lid 200 is not properly engaged. Accordingly, the numbers of detectable attachments shown in Table 1 are the maximum number of attachments 100 that may be detected, assuming that no attachment magnet 102 is also used as part of an interlock system. However, a corresponding reduction in detectable conditions may be observed in a system with mechanical switches or unipolar hall sensors if the system used one of the switches/sensors in an interlock system.

FIG. 11 illustrates an exemplary integrated circuit (IC) that may be used to implement the sensor 302. As shown in FIG. 11, the IC comprises two output pins: pin 3 corresponding to the detection of a positive magnetic field (a South pole of the magnetic element 102), and pin 4 corresponding to the detection of a negative magnetic field (a North pole of the magnetic element 102). Accordingly, the IC may be used to detect both the presence and polarity of a magnetic element 102.

In this embodiment, the sensor 302 is an omnipolar hall sensor and the IC is an omnipolar detection Hall-effect sensor IC with a dual output for South and North Pole polarity detection (pins 3 and 4). An example IC suitable for the implementation of sensor 302 is “ROHM BU5227NUZ”, which is shown FIG. 11. The IC comprises a Hall element 352, and a Schmitt-trigger 358 with built in hysteresis connected to an op-amp 356. In this way, the output pins 3,4 only switch when the magnetic flux passing through the element 352 exceeds a pre-set value, and the built-in hysteresis eliminates oscillation of the output as the magnetic element 102 is moved towards and away from the element 352. The IC delivers two different output signals 8, in dependence on the orientation (polarity) of the magnet 102. The omnipolar Hall-effect sensor IC acts as a type of digital output Hall-effect latching switch. A magnet 102 presenting a magnetic field of sufficient strength (magnetic flux density) causes pin 3/4 (depending on the polarity/orientation of the magnet 102) to change to an “ON” state (e.g. high voltage). The pin remains in the “ON” state until the magnetic field strength drops to below a pre-determined threshold (e.g. if the distance between the magnet 102 and sensor Hall element 352 is greater than x) at which point the pin will revert to an “OFF” state (e.g. low voltage) and remain in this state until a magnet 102 once again presents a magnetic field of sufficient strength. The IC thus ‘latches’ each latest state which prevents the output from switching when subject to weak fields (or small magnetic field strength variations e.g. as a result of vibration). The magnetic field strength required for the pins 3,4 to be in an “ON” state is preferably sufficiently high that a magnet 102 designed to be detected by one sensor 302 may not be detected by another sensor 302.

In an alternative embodiment, the sensor 302 may be a bipolar hall sensor. In a further alternative embodiment, the IC may be a different digital-output Hall-effect IC such as a unipolar switch, bipolar switch, or latch. Any IC suitable for detecting the presence and polarity of a magnet 102 may be used without departing from the present disclosure.

The motor unit 300 comprises a control module (not shown) including a processor, and memory. The control module may also include wireless/wired electronic communication means such as a wifi module, user interface means such as a touch-screen display and/or a physical control knob/switch. The control module is in electronic communication with the motor and controls the motor. This electronic communication is preferably a two-way communication so that both electronic instructions and electronic feedback from sensors (e.g. further Hall sensors) for detecting motor speed and torque can be transmitted and received.

The control module may store in its memory data relating to the attachment 100 corresponding to the detection(s) by sensor(s) 302 (e.g. such as the data shown in Table 2) and/or data relating to motor unit 300 settings corresponding to the detected attachment 100. In response to the detections by the sensor(s) 302, the control module may thus be configured to carry out one or more of the following processes:
present a user-interface corresponding to an operation mode corresponding to the detected attachment 100 to the user,
prevent activation of a motor of the motor unit 300 and/or prevent hazardous malfunction of the motor unit 300,
limit the speed of rotation of the motor of the motor unit 300 to within a predetermined range suitable for the detected attachment 100,
where absence of a component (e.g. attachment 100 and/or lid 200) is detected, present information related to the attachment of the component to the user, and/or
present a recipe to the user.

The control module may comprise a signal flow circuit 1200 configured to implement one or more of the control module's control functions. In particular, the circuit 1200 may allow preventing or limiting activation of the motor if an attachment 100 is not (or is incorrectly) engaged with the motor unit 300 and/or if a cover (e.g. the lid 200) is not engaged with the attachment 100a, thus increasing safety and avoiding pointless operation. The control module may display a warning to the user via its user-interface indicating which part is missing and how to attach it. Any function of the circuit 1200 may also be performed in software of the control module (and vice versa) which may introduce redundancy and improve the safety of the kitchen appliance.

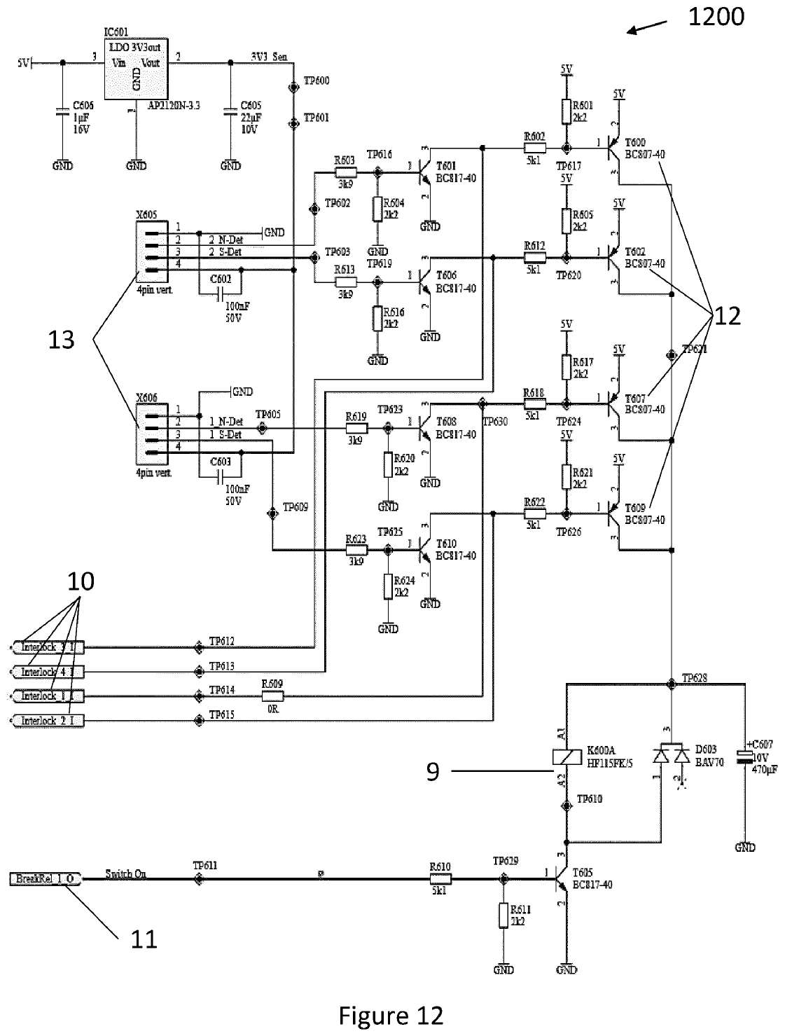

FIG. 12 illustrates an example circuit 1200 that may be used for the control module. The circuit 1200 is connected to two sensor ICs 302 (e.g. the ICs of FIG. 11) via connectors 13 (X605 and X606). By using two Hall-effect sensor ICs 302, the eight magnet (i.e. attachment recognition) combinations described above may be detected (see Layout C in Table 1). As shown in FIG. 12, the wiring is preferably carried out in such a way that a microcontroller (not shown) and the signal from the sensor ICs 302 are both connected to a power switch (preferably via a direct connection to the main power switch or relay 9).

Signals 10 and 11 are connected to a microcontroller (not shown). Signals 10 may comprise the following four signals:
Interlock_1_I—North Pole recognition (e.g. via pin 4 of the first sensor IC 302a)
Interlock_2_I—South Pole recognition (e.g. via pin 3 of the first sensor IC 302a)
Interlock_3_I—North Pole recognition (e.g. via pin 4 of the second sensor IC 302b)
Interlock_4_I—South Pole recognition (e.g. via pin 3 of the second sensor IC 302b)

Once detected, the signals 10 are preferably processed in the software of the control module comprising the circuit 1200. The required pre-set settings for the motor unit 300 corresponding to signals 10 may accordingly be set by the control module.

Independently of their processing by the control module, any of the input signals 10 (i.e. any of the recognized poles) may set the inverter stage, which inverts the 3.3V used by the sensor IC 302 to 5V used by general electronics, with the transistors 12 (T600, T602, T607, T609) set to “high”. As a result, the high side A1 of the relay 9 is switched on.

The signal 11 (BreakRel_1_O) subsequently switches the low side A2 of the relay 9. This signal is set to switch on the main switch and thus power up the motor unit 300 (e.g. the motor of the motor unit 300). This is done by using the T605 transistor. The signal 11 is set when a user starts-up the motor unit 300.

If the attachment is removed the high side A1 of the relay (power switch) 9 is powered off by switching off the transistors 12 (T600, T602, T607, T609). The software of the control module further switches off the low side A2 of the relay 9 by setting the signal 11 (BreakRel_1_O) to “low”.

The attachments 100a, 100b and lid 200 are preferably formed of a food-safe thermoplastic material, such that they can be easily formed and easily cleaned. The attachments 100a, 100b and lid 200 are preferably all dishwasher-safe.

The present disclosure has been described with particular reference to a kitchen appliance which serves as an example of an appliance. However, the present disclosure could equally well be applied to any other appliance to which one or more attachment may be fitted—for example, a vacuum cleaner, or a drill.

Further, the present disclosure has been described with particular reference to magnets and hall sensors, which serve as examples of a detectable element of an attachment and of a sensor of a base respectively. The present disclosure could equally well be applied to any other suitable detectable element and sensor combination. For example, the detectable element may be a rib that can be rotated to present a plurality of differently-shaped faces to a sensor comprising apertures shaped to detect each rib face shape. Or, as a further example, the sensor may be a light sensor and the detectable element a light emitting diode configured to transmit light waves of a plurality of wavelengths.

It will be understood that the present invention has been described above purely by way of example, and modifications of detail can be made within the scope of the invention.

Each feature disclosed in the description, and (where appropriate) the claims and drawings may be provided independently or in any appropriate combination.

Reference numerals appearing in the claims are by way of illustration only and shall have no limiting effect on the scope of the claims.

1-23. (canceled)

24. A kitchen appliance comprising a body to which one or more attachments may be fitted, the body comprising at least one sensor configured to distinguish between at least three conditions relating to a detectable element associated with an attachment, and a controller configured to identify a parameter relating to the attachment in dependence upon the sensed condition.

25. The kitchen appliance of claim 24, wherein the conditions comprise: the absence of a detectable element, and the presence of a detectable element having either a first or a second state.

26. The kitchen appliance of claim 25, wherein the detectable element comprises a magnet, and the first and second states comprise each polarity of a magnetic field of the magnet respectively.

27. The kitchen appliance of claim 24, wherein the sensor is a hall sensor, preferably an omnipolar hall sensor.

28. The kitchen appliance of claim 24, wherein the body comprises a motor unit, optionally wherein the controller is configured to permit or prevent actuation of a motor of the base in dependence on the sensed condition of the detectable element; preferably wherein the attachment comprises a food processing tool.

29. The kitchen appliance of claim 24, wherein the parameter relating to the attachment comprises at least one of: the absence of an attachment, the identity of the attachment, a condition of the attachment, and a working parameter of the attachment.

30. The kitchen appliance of claim 24, wherein, in dependence upon the sensed condition, the sensor transmits a ternary code to the controller.

31. The kitchen appliance of claim 24, wherein the body comprises a plurality of sensors, each configured to distinguish between at least three conditions relating to a detectable element associated with an attachment.

32. The kitchen appliance of claim 24, wherein the body is configured for engagement with an attachment in at least two orientations, optionally wherein an engagement region of the body has a substantially triangular shape, or rounded triangular shape, preferably a substantially equilateral triangular shape.

33. The kitchen appliance of claim 32, wherein the body comprises two sensors, each configured to distinguish between at least three conditions relating to a detectable element associated with an attachment, each sensor being provided adjacent a distinct side of the triangular engagement region, preferably at, or near, the midpoint of each side.

34. The kitchen appliance of claim 24, wherein the sensor is provided adjacent an engagement region of the body, preferably adjacent an edge of the engagement region, optionally wherein the sensor is provided adjacent a sidewall of the engagement region.

35. An attachment for a kitchen appliance, the attachment having an engagement region for fitting to an appliance body in at least two orientations, and comprising a magnet at or adjacent the engagement region configured to present one of a north pole or a south pole to a sensor of the appliance body.

36. The attachment of claim 35, wherein the engagement region has a substantially triangular shape or rounded triangular shape, preferably a substantially equilateral triangular shape.

37. The attachment of claim 35, wherein the attachment is configured for engagement with an accessory, and further comprises a biased member arranged to bias the magnet away from the sensor of the appliance body if the accessory is not engaged with the attachment, optionally wherein the biased member comprises a rod provided in a handle of the attachment; preferably wherein the magnet is engaged with the rod and/or wherein the rod is provided on a rail.

38. An adaptor for a kitchen appliance, wherein the adaptor is configured to engage with an attachment and a body of the kitchen appliance; and comprises at least one aperture configured to receive a magnet, optionally wherein the presence and polarity and/or absence of the magnet in the aperture forms a ternary code that identifies a parameter relating to the adaptor.

39. The adaptor of claim 38, wherein the aperture comprises a biased member arranged to bias a magnet in the aperture away from the body if the attachment is not engaged with the adaptor.

40. The kitchen appliance of claim 24, further comprising an attachment comprising at least one detectable element configured for sensing by the at least one sensor of the base.

41. The kitchen appliance of claim 40, wherein the attachment has an engagement region for fitting to an appliance body in at least two orientations, and comprising a magnet at or adjacent the engagement region configured to present one of a north pole or a south pole to a sensor of the appliance body.

42. The kitchen appliance of claim 40, further comprising wherein the adaptor is configured to engage with an attachment and a body of the kitchen appliance; and comprises at least one aperture configured to receive a magnet, optionally wherein the presence and polarity and/or absence of the magnet in the aperture forms a ternary code that identifies a parameter relating to the adaptor; and wherein the adaptor is engaged with the attachment and the body; and wherein the detectable element comprises a magnet provided in the adaptor aperture.
